(19) United States
(12) Patent Application Publication
(10) Pub. No.: US 2024/0247765 A1
(43) Pub. Date: Jul. 25, 2024

(54) PIPELINE CORROSION INHIBITOR OPTIMIZATION AND CONTROL

(71) Applicant: SAUDI ARABIAN OIL COMPANY, Dhahran (SA)

(72) Inventors: Hassan Mohammadali AL MATOUQ, Juaymah (SA); Mohammed Saeed ALHAMAQI, Juaymah (SA); Rida Majed BIN HASHIM, Juaymah (SA)

(73) Assignee: SAUDI ARABIAN OIL COMPANY, Dhahran (SA)

(21) Appl. No.: 18/156,531

(22) Filed: Jan. 19, 2023

(51) Int. Cl. F17D 3/12; F17D 5/02; G05B 19/416

(52) U.S. Cl. CPC F17D 3/12; F17D 5/02; G05B 19/4166; G05B 2219/37371

(57) ABSTRACT

The present disclosure relates to pipeline corrosion inhibitor optimization and control. In an example, a failure probability representative of a likelihood of a pipeline corrosion failure and a consequence level representative of a consequence from the pipeline corrosion failure can be computed. A risk matrix can be generated and used to identify an inhibitor concentration based on the failure probability and consequence. A dosage of a corrosion inhibitor for mitigating corrosion of a pipeline can be computed based on the inhibitor concentration. In some examples, the dosage of the corrosion inhibitor can be adjusted based on a modification factor computed at least based on a corrosion rate measured for the pipeline.

### FIELD OF THE DISCLOSURE

This disclosure relates generally to pipeline corrosion monitoring, and more particularly, to pipeline corrosion inhibitor optimization and control.

### BACKGROUND OF THE DISCLOSURE

Corrosion is a natural process that converts a refined metal into a more chemically stable oxide. Pipeline corrosion occurs on both inside and outside of any pipe and related structures exposed to corrosive elements/environment. Reactions to the substances carried by pipelines as well as external conditions such as weather all contribute to pipeline corrosion. The most common material used in hydrocarbon pipe manufacturing is carbon steel.

Pipelines suffer from a number of corrosion forms, ranging from pitting corrosion, uniform corrosion, galvanic corrosion, crevice corrosion and microbiologically influenced corrosion, etc. To treat or inhibit internal pipeline corrosion, chemical treatments are used. Corrosion inhibitors or anti-corrosive chemical compounds are injected or added into a pipeline to decrease a corrosion rate of the pipeline. A pipeline corrosion inhibitor is a chemical compound that halts or slows down the corrosion process in a pipeline. The pipeline corrosion inhibitor works by reacting with a fluid in the pipeline, making it more inert and/or creating a film on the pipeline surface, making pipeline corrosion less likely. Pipeline corrosion inhibitors can be applied either directly to a well formation or by injecting it at regular intervals in the pipeline using special valves.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method can include computing, by one or more processors, a failure probability representative of a likelihood of a pipeline corrosion failure, computing, by the one or more processors, a consequence of failure representative of the impact of the pipeline corrosion failure, generating, by the one or more processors, a risk matrix, identifying, by the one or more processors, a given inhibitor concentration using the risk matrix based on the failure probability and the failure consequence, and computing, by the one or more processors, a dosage of a corrosion inhibitor for mitigating corrosion of a pipeline based on at least the given inhibitor concentration.

In another embodiment consistent with the present disclosure, a system can include memory to store machine-readable instructions and data, and one or more processors operable to access the memory and execute the machine-readable instructions. The data can include probability factors table, a probability ranking table, consequence factors table and consequence ranking table. The machine-readable instructions can include a corrosion inhibitor optimizer. The corrosion inhibitor optimizer can include a failure probability and consequence calculator programmed to compute a failure probability ranking representative of a likelihood of a pipeline corrosion failure based on the probability factors and the probability ranking table, and compute a failure consequence ranking representative of the impact of the pipeline failure based on the consequence factors table and the consequence ranking table. The corrosion inhibitor optimizer can further include a concentration engine programmed to identify a risk level using a risk matrix to identify an associated inhibitor concentration based on the failure probability and the consequence, and an inhibitor dosage controller programmed to compute a dosage of the corrosion inhibitor based on the identified risk level.

Any combinations of the various embodiments and implementations disclosed herein can be used in a further embodiment, consistent with the disclosure. These and other aspects and features are better appreciated according to the following description of certain embodiments presented herein in accordance with the disclosure and the accompanying drawings and claims.

### BRIEF DESCRIPTION OF THE DRAWINGS

FIG. 1 is an example of a corrosion inhibitor optimizer.

FIG. 2 is an example of a corrosion inhibitor injection system.

FIG. 3 is an example of probability tables that can be used for computing a failure probability ranking.

FIG. 4 is an example of consequence tables that can be used for computing a failure consequence ranking.

FIG. 5 is an example of a matrix with cells having an associated risk level.

FIG. 6 is an example of a matrix with cells having an associated inhibitor concentration.

FIG. 7 is an example of a method for determining a dosage of a corrosion inhibitor.

FIG. 8 is an example of a method for optimizing an injection rate of a corrosion inhibitor.

FIG. 9 is an example of a method for determining a modification factor for inhibitor concentration adjustment.

FIG. 10 is an example corrosion mitigation system that can be used to perform methods according to an aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to pipeline corrosion inhibitor optimization and control. Corrosion can be one of the primary causes of problems in oil and natural gas pipelines. As oil and gas pipeline materials react with highly corrosive media (e.g., H₂S, CO₂, brackish water, etc.), the structural integrity of the pipeline may be degraded, potentially leading to leaks, rupture, and potentially catastrophic events. To protect pipelines from corrosion, operators utilize chemical injection systems, where a precisely controlled amount of a corrosion inhibitor chemical is injected directly into the pipeline.

A common issue with chemical injection systems is determining a proper or correct amount of corrosion inhibitor for pipeline corrosion mitigation. If a pipeline is under-dosed, a corrosion inhibition effectiveness is reduced, which can increase (e.g., expedite) a pipeline degradation rate in some cases. While over-dosing can be used to counteract pipeline corrosion, such an approach is costly and results in chemical waste.

A corrosion inhibitor optimizer is described herein that can be used to mitigate or reduce a likelihood of under-dosing and over-dosing by determining an optimal dosage for a corrosion inhibitor for injecting into the pipeline. While examples are described herein for mitigating or reducing pipeline corrosion with respect to oil and/or gas pipelines, for example, as used downhole (e.g., in an underground part of oil well operation), in other examples, the corrosion inhibitor optimizer can be used to mitigate corrosion upstream, or in other non-oil and gas pipeline industries.

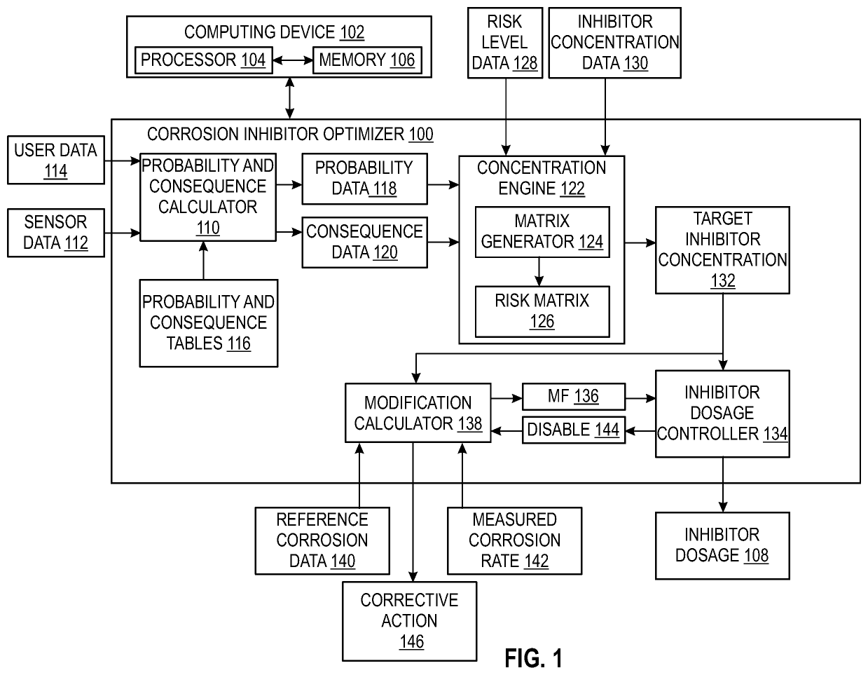

FIG. 1 is an example of a corrosion inhibitor optimizer 100. The corrosion inhibitor optimizer 100 can be used to determine an amount of corrosion inhibitor that needs to be injected or introduced into a pipeline. The corrosion inhibitor optimizer 100 can be used to minimize or reduce a likelihood of pipeline corrosion failure (e.g., metal of the pipeline becoming brittle and losing cohesion). The corrosion inhibitor optimizer 100 can be implemented using one or more modules, shown in block form in the drawings. The one or more modules can be in software or hardware form, or a combination thereof. In some examples, the corrosion inhibitor optimizer 100 can be implemented as machine readable instructions for execution on a computing device 102, as shown in FIG. 1.

The computing device 102 can include any computing device, for example, a desktop computer, a server, a controller, a blade, a mobile phone, a tablet, a laptop, a personal digital assistant (PDA), and the like. The computing device 102 can include a processor 104 and a memory 106. By way of example, the memory 106 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 104 could be implemented, for example, as one or more processor cores. The memory 106 can store machine-readable instructions (e.g., which can include the corrosion inhibitor optimizer 100) that can be retrieved and executed by the processor 104. Each of the processor 104 and the memory 106 can be implemented on a similar or a different computing platform. The computing platform could be implemented in a computing cloud. In such a situation, features of the computing platform could be representative of a single instance of hardware or multiple instances of hardware executing across the multiple of instances (e.g., distributed) of hardware (e.g., computers, routers, memory, processors, or a combination thereof). Alternatively, the computing platform could be implemented on a single dedicated server or workstation. In some examples, the computing device 102 is representative of a programmable logic controller (PLC) controller.

According to the examples described herein, the corrosion inhibitor optimizer 100 can compute an inhibitor dosage 108 for a corrosion inhibitor that is to be injected into the pipeline. For instance, the corrosion inhibitor optimizer 100 (e.g., implemented as an executable program on the PLC controller) can cause an output interface (e.g., an output card) of the PLC controller to provide an inhibitor control signal based on the inhibitor dosage 108. Thus, in the given example, the corrosion inhibitor optimizer 100 can cause the inhibitor control signal to be provided for adjusting an injection rate of the corrosion inhibitor into the pipeline. The inhibitor control signal can be representative of the inhibitor dosage 108. In examples wherein the corrosion inhibitor optimizer 100 is implemented on a remote computing device, for example, a computer (e.g., desktop computer, laptop, etc.), the corrosion inhibitor optimizer 100 can provide the inhibitor dosage 108 to a PLC controller to cause the PLC controller to provide the inhibitor control signal based on the inhibitor dosage 108.

As shown in the example of FIG. 1, the corrosion inhibitor optimizer 100 includes a probability and consequence calculator 110 that receives sensor data 112 and user data 114. The sensor data 112 can include a number of measurements from sensors distributed or located on the pipeline for measuring physical changes in an environment (e.g., within the pipeline) that contribute to or cause pipeline corrosion. In some instances, one or more sensors do not make a direct measurement of a desired physical quantity, and in these examples a remote device (e.g., computer, server, etc.) can be used to analyze (e.g., compute) the measured values of other physical phenomena to obtain a desired quantity. For example, the sensor data 112 can include water cut sensor data characterizing a water content (e.g., water cut) of crude oil. A water cut sensor (or meter) can be positioned in the pipeline to measure a water cut of an oil-water mixture as this mixture flows through the pipeline. The water cut sensor can output water content changes (e.g., in barrel per day (BPD), which can be analyzed using on-board electronics (or off-line, such as a remote computing device or in a cloud computing environment) to determine the water cut in the oil-water mixture, for example using a multiphase flow meter. In some examples, water cut is representative of a water cut range, expressed as a percentage, indicating an amount of water as a percentage of the oil-water mixture.

In some examples, the sensor data 112 includes hydrogen sulfide (H₂S) sensor data characterizing an amount of hydrogen sulfide gas (e.g., in PPM) flowing through the pipeline. H₂S is a gas commonly found during drilling and production of crude oil and natural gas. An H₂S sensor can be used to measure the amount of H₂S that is the pipeline (e.g., in the crude oil). H₂S is formed from either decomposing organic matter or from bacteria consuming naturally occurring petroleum and produces an offensive “rotten egg” odor in low concentrations. H₂S occurs naturally in some groundwater and may be found in wells drilled for oil or natural gas. When combined with water, it forms sulfuric acid (H₂SO₄), a strongly corrosive acid. In some examples, the sensor data 112 includes carbon dioxide (CO₂) sensor data characterizing an amount of CO₂ (e.g., in PPM) in the pipeline. A CO₂ sensor can be used to measure the amount of carbon dioxide gas in the pipeline (e.g., in the crude oil). CO₂, for example, is an acidic compound often present in natural gas and crude oil. It becomes particularly corrosive when dissolved in water, leading to pitting and other types of corrosion.

Corrosion primarily caused by dissolved CO₂ is commonly referred to as sweet corrosion; whereas corrosion due to a combined presence of dissolved CO₂ and H₂S can be referred to as sour corrosion, provided that CO₂ partial pressure is no more than double the pressure of H₂S. For example, to determine if corrosion is sweet or sour for ranking assignment, the failure probability and consequence calculator 110 can evaluate a ratio of partial pressure computed based on the CO₂ and H₂S sensor data. For example, if the ratio of the partial pressure is greater than a first threshold (e.g., more than 0.5), the corrosion is considered sweet. By contrast, if the ratio of the partial pressure is less than or greater than the threshold, the corrosion is considered sour. In some examples, the sensor data 112 includes flow rate data characterizing a speed or rate (e.g., a flow velocity) at which oil or gas is flowing through the pipeline. A flow meter (or sensor) can be used to measure the flow velocity of an oil or gas mixture flowing in the pipeline.

The user data 114 can include information/data identifying corrosion mitigation methodologies that are used by an operator to reduce pipeline corrosion effects, and consequences of these effects. Each consequence of the user data 114 can identify a respective result or cause that can occur from unmitigated or untreated corrosion caused by corrosive failure of the pipeline and can be referred to herein as a “consequence of failure.” Each consequence of failure can include, for example, a production loss (e.g., in million barrels per day (MBPD) of oil), an environmental damage (e.g., an amount of time that an oil spill or leak remains in a given area, such as offshore, remote, or residential area), people's safety (e.g., an impact that the oil spill or leak can have on a population, such as injury, fatality, etc.), a company's reputation (e.g., on a geographical level), and/or other type of consequences of failures.

The corrosion mitigation methodologies can identify techniques and/or corrosion monitoring services (e.g., sensor devices used to measure or capture physical changes with respect to the pipeline) that are used (e.g., deployed, implemented, etc.) by the operator to minimize or reduce pipeline corrosion risk and can be referred to as a “corrosion mitigation source.” The corrosion mitigation methodologies can include, for example, scrapability (e.g., whether an operator has a pipeline cleaning program in place), an in-line inspection (ILI) (e.g., whether the operator has ILI tools for corrosion detection, for example, Ultrasonic testing/Magnetic Flux Leakage (UT/MFL) tools, and service corrosivity (e.g., whether the operator can detect sweet and/or source corrosion)). Other or different types of corrosion mitigation methodologies are also contemplated by the present disclosure.

The corrosion monitoring services can identify corrosion monitoring sensor techniques that the operator can use or employ for measuring operating characteristics with respect to the pipeline. The corrosion monitoring sensor techniques can include, for example, a water cut sensor technique, a flow velocity sensor technique, and/or a different type of sensor monitoring technique that can be used to detect or measure physical changes in a pipeline environment. The water cut sensor technique can be associated with a water cut range, expressed as a percentage, indicating an amount of water likely in an oil-water mixture. The flow velocity sensor technique can be associated with a velocity at which a gas or a liquid flows through the pipeline. In some examples, the user data 114 can identify a weight for each corrosion probability and consequence factor. For example, each weight can be user-defined according to engineering standards and/or practices. Different pipeline operators can have different weight and criteria based on operating conditions.

The failure probability and consequence calculator 110 can receive factors and ranking tables 116. The tables 116 include a probability of failure factors and ranking tables as well as consequence of failure factors and ranking tables. The factors tables can specify the elements/factors for a pipeline corrosion failure probability and consequence, and each element/factor therein can be associated with a respective value (weight) representative of its importance. The consideration of the totality of these elements/factors allows computing a ranking value in accordance to the ranking tables. In some examples, ranking table can include ranking ranges. The ranking ranges of the ranking table can be a numerical or alphabetical value and/or range of values that has been assigned to represent a given probability/consequence of failure occurring.

In an example, the failure probability ranking table includes five (5) probability and/or probability range value(s) each indicative of a probability of the pipeline corrosion failure. For example, a first probability range “0-1” can indicate a “very low” likelihood (or probability) of the pipeline corrosion failure, a second probability range “2-3” can indicate a “low” likelihood of the pipeline corrosion failure, a third probability range “4-5” can indicate a “medium” likelihood of the pipeline corrosion failure, a fourth probability range “6-7” can indicate a “high” likelihood of the pipeline corrosion failure, and a fifth probability “8” or probability range “8-9” can indicate a “very high” likelihood of the pipeline corrosion failure. Each probability and/or probability range value can be associated with a ranking value that increases as the probability and/or probability range value increases in the probability of failure table.

The failure consequence ranking table can specify the expected impact of pipeline failure. Each level of the failure consequence ranking table can be a numerical or alphabetical value and/or range of values that has been assigned to represent a given consequence level resulting from the pipeline corrosion failure. In an example, the failure consequence ranking table includes five (5) ranges each indicative of a consequence level resulting from the pipeline corrosion failure. For example, a first level “0-3” can indicate a “very low” consequence level resulting from the pipeline corrosion failure, a second level “4-8” can indicate a “low” consequence level resulting from the pipeline corrosion failure, a third level “9-13” can indicate a “medium” consequence level resulting from the pipeline corrosion failure, a fourth level “14-17” can indicate a “high” consequence level resulting from the pipeline corrosion failure, and a fifth level “18-20” can indicate a “very high” consequence level resulting from the pipeline corrosion failure. Each of the consequence levels of the failure consequence ranking table can be associated with a ranking value that increases as each consequence increases therein. While the failure probability ranking table and the failure consequence ranking table using different ranking systems, in some examples, these table can use a similar ranking system (e.g., 1-5 for both probability of failure and consequence of failures).

In some examples, the probability of failure tables can be used for generating failure probability data 118. The failure probability factors table can identify each (or at least a subset thereof) corrosion risk source (which can be referred to in the probability factors table as a “probability element”) and a value (weight) for each source (e.g., according to the sensor data 112 and/or user data 114). The failure probability and consequence calculator 110 can process assigned values to corresponding factors in the failure probability factors table to compute a probability value representative of an overall failure probability (e.g., that considers a contribution of each corrosion source). The failure probability and consequence calculator 110 can compare the probability value to the probability ranking table to identify a corresponding failure probability representative of a likelihood of the pipeline corrosion failure. The failure and consequence calculator 110 can output the probability data 118 characterizing the failure probability.

In some examples, the consequence of failure tables are used for generating consequence data 120. The failure consequence factors table can identify each consequence (or at least a subset thereof) resulting or caused by the pipeline corrosion failure (which can be referred to in the consequence factors table as a “consequence element”), and a value (weight) assigned to each consequence factor (e.g., according to the sensor data 112 and/or user data 114). The failure and consequence calculator 110 can process assigned consequence values to corresponding consequence factors in the failure consequence factors table to compute a consequence value representative of an overall consequence value (e.g., that considers a contribution of each consequence of the pipeline corrosion failure). The failure probability and consequence calculator 110 can compare the consequence value to the consequence ranking table to identify a consequence level representative of the pipeline corrosion failure impact (e.g., regardless of a type of consequence). The failure probability and consequence calculator 110 can output the consequence data 120 characterizing the consequence level.

The corrosion inhibitor optimizer 100 includes a concentration engine 122 with a matrix generator 124 that can generate a risk matrix 126 based on risk level data 128 and inhibitor concentration data 130. As described herein, the concentration engine 122 can use the probability data 118 and the consequence data 120 as a look-up parameter to identify a desired inhibitor concentration. The concentration engine 122 can generate the risk matrix 126 to have a dimensionality based on a number of probability and consequence rankings specified in corresponding ranking tables 116. For example, if the probability ranking table includes five (5) probability rankings and the consequence ranking table includes five (5) consequence rankings, the risk matrix 126 generated by the concentration engine 122 can be a 5×5 matrix. The risk matrix 126 can include a number of columns and rows. Each row can specify a given likelihood of corrosion failure, and each column can specify a given consequence level resulting from the pipeline corrosion failure. While the risk matrix 126 is described herein as a table, in other examples, the risk matrix 126 can be implemented as an array, or using a different data organization scheme.

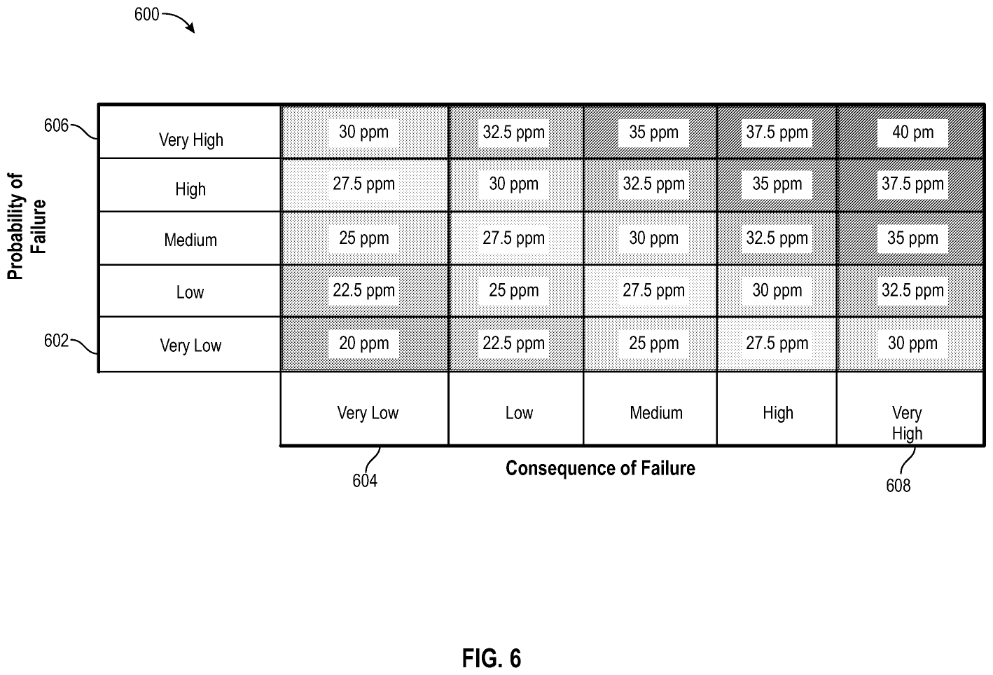

The risk level data 128 can identify a number of risk levels or values and can be assigned by the matrix generator 124 to a corresponding cell of the risk matrix 126. In some examples, the matrix generator 124 can provide the risk matrix 126 (e.g., as shown in FIG. 6) with each cell assigned an associated inhibitor concentration based on the inhibitor concentration data 130, which can identify or specify an inhibitor concentration for each cell of the risk matrix 126. The failure probability and consequence provided by the failure and consequence calculator 110 can be used as lookup values into the risk matrix 126 to identify a target inhibitor concentration 132. Thus, in some examples, the risk matrix 126 can be provided based on the inhibitor concentration data 130.

In some examples, the inhibitor concentration data 130 can identify an amount of inhibitor concentration for a respective risk level identified by the risk level data 128. The matrix generator 124 can assign each cell a corresponding inhibitor concentration from the risk level data 128 based on an assigned risk level for that cell to provide the risk matrix 126. For example, for a given cell during generation of the risk matrix 126 the matrix generator 124 associates a given risk level to the corresponding inhibitor concentration from the risk level data 128. With respect to inhibitor concentration for the pipeline, it can be determined based on an inhibitor efficiency as well as economic factors (e.g., cost of procuring the inhibitor). For example, the concentration engine 122 can receive inhibitor efficiency and pricing information for the inhibitor to be used for mitigating corrosion and use this information to determine an inhibitor concentration range. The concentration engine 122 can assign a subset range from the inhibitor concentration range to a corresponding risk level and this assignment can be characterized by the inhibitor concentration data 130. For example, an inhibitor with an inhibitor concentration range of 20-40 ppm concentration can assign a lowest risk level 20 ppm concentration and a highest risk level 40 ppm concentration. Accordingly, in some instances, the concentration engine 122 can provide the inhibitor concentration data 130, as shown in FIG. 1.

In some examples, the matrix generator 124 can determine (e.g., during risk matrix generation) an amount of risk to assign each cell therein according to equation (1):

$$R ( P , C ) = P + C - 1 , \qquad ( 1 )$$

wherein P is a failure probability ranking, C is a failure consequence ranking, and R is a computed risk value (or level).

In some examples, the values of P and C in equation (1) can vary from 1 to 5 (e.g., very low to very high). By way of example, if P is medium (3) and C low (2), the computed risk value R=3+2−1=4. As a further example, if P is high (4) and P is very low (1), the computed risk value R=4+1−1=4. Accordingly, the matrix generator 124 can determine a risk value for each cell of risk matrix 126 according to equation (1).

In some examples, to compute or determine the inhibitor concentration that is to be assigned to each cell of the risk matrix 126 (e.g., during risk matrix generation), the matrix generator 124 can employ equation (2),

$$PPM = 17.5 + 2.5 ( P + C - 1 ) , \qquad ( 2 )$$

wherein P is the probability failure, C is the failure consequence, and PPM is a computed inhibitor concentration for a given cell of the risk matrix 126.

In some examples, to compute or determine the inhibitor concentration that is to be assigned to each cell of the risk matrix 126 (e.g., during risk matrix generation), the matrix generator 124 can employ equation (3),

$$PPM = 17.5 + 2.5 ( R ) , \qquad ( 3 )$$

wherein R is the computed risk value from equation (1), and PPM is the computed inhibitor concentration for the given cell of the risk matrix 126.

In some examples, the concentration engine 122 can output a target inhibitor concentration 132 using the probability data 118 and the consequence data 120 based on the risk matrix 126. For example, once a corresponding cell of the risk matrix 126 is identified, an inhibitor concentration associated with the corresponding cell can be provided by the concentration engine 122 as the target inhibitor concentration 132, as shown in FIG. 1. For example, the concentration engine 122 can use the failure probability and consequence rankings to locate or identify a cell (e.g., a cell address) that is common or shared. For example, referred to herein as a “given example,” the failure probability corresponds to a “medium” likelihood of the pipeline corrosion failure, and the consequence corresponds to a “low” consequence level resulting from the pipeline corrosion failure. In the given example, the concentration engine 122 can use the failure probability to locate the row that specifies a “medium” likelihood of the pipeline corrosion failure and the consequence to locate the column that specifies a “low” consequence level resulting from the pipeline corrosion failure in the risk matrix 126. An intersection of the row and column in the given example identifies the cell and this cell can be referred to as a common or shared cell. The concentration engine 122 can provide an inhibitor concentration assigned to the common cell (e.g., a cell address for the common cell) as the target inhibitor concentration 132.

In some examples, referred to herein as “a second example,” the concentration engine 122 can use the failure probability and consequence data 118-120 to identify a given cell of the risk matrix 126 and thus a risk level assigned to the given cell. The concentration engine 122 can use the risk level assigned to the given cell to search the inhibitor concentration data 130 to identify the target inhibitor concentration 132 associated with the risk level that has been assigned to the given cell.

The corrosion inhibitor optimizer 100 further includes an inhibitor dosage controller 134 that can output the inhibitor dosage 108 based on at least the target inhibitor concentration 132. For example, the inhibitor dosage controller 134 can cause an injection rate of the corrosion inhibitor being injected into the pipeline to be adjusted based on the target inhibitor concentration 132. The inhibitor dosage controller 134 can calculate a volume of the inhibitor (e.g., the dosage) based on at least the target inhibitor concentration 132 to be injected into the pipeline and also potentially based on a pipeline's flow rate and water cut data, which can be provided based on the sensor data 112, as shown in FIG. 1. The inhibitor dosage 108 can be provided to a dosing system, for example, as described herein, to control a dosage rate (or an injection rate) of the inhibitor into the pipeline to counteract or reduce corrosion of the pipeline.

In some instances, mixing of corrosion inhibitor with water can be reduced or inhibited because of low flow velocity of the water, flow regimes that minimize inhibitor-water mixing, presence of sediments and dirt in the pipeline, and pipeline topology, which affects an effectiveness of the inhibitor concentration mitigating pipeline corrosion. To improve corrosion inhibition in less favorable corrosion inhibitor conditions, the inhibitor dosage controller 134 can calculate the inhibitor dosage 108 based on a modification factor (MF) 136. For example, the inhibitor dosage controller 134 can multiply the inhibitor dosage 108 by the MF 136 to compute an updated inhibitor dosage, which can be used by the inhibitor dosage controller 134. In some examples, the MF 136 is a value that ranges from a respective value (e.g., 1) to another value (e.g., 2). As such, the corrosion inhibitor optimizer 100 can provide the inhibitor dosage 108 that takes into account non-ideal inhibitor-water mixing conditions.

A modification calculator 138 of the corrosion inhibitor optimizer 100 can provide the MF 136, as shown in FIG. 1. The modification calculator 138 provides the MF 136 based on reference corrosion data 140 and a measured (or current) corrosion rate 142. The measured corrosion rate 142 can characterize a determined corrosion rate for the pipeline. In some examples, a baseline corrosion rate sensor is coupled to the pipeline (e.g., in some instances a reference or base pipeline) to track a corrosion rate of the pipeline for different inhibitor concentrations. Because a corrosion rate sensor is used to provide the corrosion rate, corrosion rates provided by the baseline corrosion rate sensor can take into account a time-variation of an uncontrolled environment in a field. The baseline corrosion rate sensor can be positioned with respect to the pipeline in a location where a flow regime promotes mixing (e.g., after expansion loops) and in relative close proximity of an inhibitor injection site on the reference pipeline. The reference corrosion data 140 can include a number of baseline corrosion rates for different inhibitor concentrations. In some examples, the baseline corrosion rates for the different inhibitor concentrations can be determined in a lab environment to provide the reference corrosion data 140. Thus, in some instances, the reference corrosion data 140 can identify specific inhibitor concentrations and an associated expected corrosion rate (e.g., an average corrosion rate). In some examples, the measured corrosion rate 142 can be outputted by a corrosion rate sensor coupled to the pipeline to measure corrosion characteristics of the pipeline in response to injecting the inhibitor at the dosage rate at the target inhibitor concentration 132.

In some examples, the modification calculator 138 can provide the MF 136 with a modification value based on the target inhibitor concentration 132, the reference corrosion data 140 and the measured corrosion rate 142. The modification calculator 138 can compare the reference corrosion rate 140 relative to measured corrosion rate 142. If the measured corrosion rate 142 is greater than the actual corrosion rate, the modification calculator 138 can provide the MF 136 for adjusting the inhibitor dosage 108 through the inhibitor dosage controller 134. The MF 136 can be such that a value therein increases an amount of inhibitor dosage 108 to allow achieving the target inhibitor concentration 132, as described herein.

In some examples, the modification calculator 138 can compute a corrosion deviation amount as a percentage from the expected/reference corrosion rate using the equation (4):

$$CD = \frac{C - E}{C} \times 100 \% , \qquad ( 4 )$$

wherein C corresponds to the measured corrosion rate 142, E corresponds to an expected corrosion rate at the target inhibitor concentration 132, and CD corresponds to the corrosion deviation amount.

The modification calculator 138 can compare the corrosion deviation amount relative to a corrosion deviation amount threshold. If the corrosion deviation amount is less than the corrosion deviation amount threshold, the MF 136 can be lowered by a percentage factor (e.g., by 20%) up to a minimum of one (1) by the modification calculator 138. The inhibitor dosage controller 134 or a different module, system, or user can provide a disable command 144 to the modification calculator 138 to stop (e.g., halt) inhibitor dosage modifications and thus cause the inhibitor dosage controller 134 to enter a monitoring state for a period of time (e.g., a week) to allow the change to appear in corrosion rate measurements and thus be reflected in the measured corrosion rate 142, as shown in FIG. 1. For example, the inhibitor dosage controller 134 can initiate a timer (e.g., a software timer) for the period of time and once expired enable or cause the modification calculator 138 to provide the MF 136 according to the examples described herein.

In some examples, if the corrosion deviation amount is greater than or exceeds the corrosion deviation amount threshold by a given amount (e.g., percentage, value, etc.), the MF 136 can be increased by the modification calculator 138 by a percentage factor (e.g., 20%). It is assumed that the target inhibitor concentration 132 is not being achieved within the pipeline. The increase or decrease of the MF 136 as described can correspond to providing the MF 136 with an appropriate modification value (e.g., numerical or percentage value) based on whether the target inhibitor concentration 132 is being achieved within the pipeline. The modification calculator 138 can enter a monitoring state for a period of time during which the modification calculator 138 does not modify the target inhibitor concentration 132. The modification calculator 138 can compute a new corrosion deviation amount according to the examples described following the monitoring period. If the increase in the MF 136 reduced the corrosion deviation amount by a threshold (e.g., 5%), then the modification calculator 138 can further increase or decrease the MF 136 according to the examples described herein.

In some examples, the increase in concentration of the corrosion inhibitor in the pipeline has minimal to no effect on the corrosion rate of the pipeline. The modification calculator 138 can determine a corrosion rate decrease based on a number of corrosion rate measurements (e.g., from one or more corrosion rate sensors). The modification calculator 138 can compare each corrosion rate decrease relative to a corrosion rate decrease threshold. If the corrosion rate decrease is not greater than or equal to the corrosion rate decrease threshold, the modification calculator 138 can output a corrective action request 146. The corrective action request 146 can be provided to a user device (e.g., a portable device or stationary device) or rendered on a display to alert the operator that manual cleaning of the pipeline is needed. For example, the corrective action request 146 can indicate that the pipeline is to be cleaned using a scraper to remove sediments and dirt and thus remove contaminants or substances that may be impeding corrosion inhibitor flow/form through the pipeline (e.g., preventing the inhibitor from traveling properly through the pipeline/formed on the pipeline surface). In some examples, the MF 136 can be reduced to a minimal MF prior to the modification calculator 138 outputting the corrective action request 146. While examples are described herein, in which the modification calculator 138 provides the corrective action request 146, in other examples, the inhibitor dosage controller 134 can be programmed to provide the corrective action request 146 in a same or similar manner as the modification calculator 138.

By using the corrosion inhibitor optimizer 100 a process for pipeline corrosion protection and mitigation can be optimized and improved over existing processes, which do not use the corrosion inhibitor optimizer 100, as described herein. The corrosion inhibitor optimizer 100, as described herein, can be used to mitigate or reduce a likelihood of under-dosing, which can limit a corrosion inhibition effectiveness, and over-dosing, which can result in chemical waste and additional costs to an operator. The corrosion inhibitor optimizer 100 is applicable to all hydrocarbon pipelines, including upstream and downstream pipelines. The corrosion inhibitor optimizer 100 can adjust and maintain a chemical injection pump rate by sending control signals to actuators of a dosing system to set a rate at which the corrosion inhibitor is injected based on the optimization criteria, as described herein.

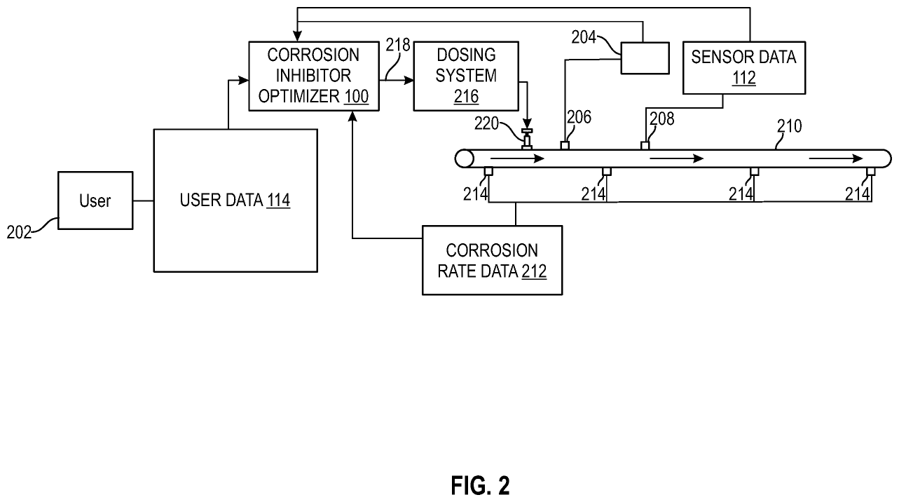

FIG. 2 is an example of a corrosion inhibitor injection system 200. The system 200 includes the corrosion inhibitor optimizer 100, as shown in FIG. 1. Thus, reference can made to the example of FIG. 1 in the example of FIG. 2. As described herein, the corrosion inhibitor optimizer 100 can receive the sensor data 112 and the user data 114. The user data 114 can be provided by a user 202, as shown in FIG. 2, for example, using a computer system, as described herein. In some examples, the corrosion inhibitor optimizer 100 can receive flow sensor data 204 from a flow sensor 206, as shown in FIG. 2. In some examples, the sensor data 112 includes the flow sensor data 204. The sensor data 112 can be provided by one or more sensors 208, as shown in FIG. 2. The one or more sensors 208 can be used to measure or sense physical changes in a pipeline 210 that contribute to or cause pipeline corrosion, for example, as described herein (e.g., with respect to FIG. 1). For example, the pipeline 210 can be implemented as part of an oil or gas topology through which oil or gas mixture can flow, shown with arrows in the example of FIG. 2. In some examples, the corrosion inhibitor optimizer 100 can receive corrosion rate data 212, which can include the measured corrosion rate 142, as shown in FIG. 1. A number of corrosion sensors 214 can be distributed on the pipeline 210 to measure the corrosion rate therein and provide the corrosion rate data 212. Thus, the corrosion rate data 212 can include a number of measured corrosion rates for each of the corrosion sensors 214, as shown in FIG. 2.

According to the examples described herein, the corrosion inhibitor optimizer 100 can compute the inhibitor dosage 108, as shown in FIG. 1. The inhibitor dosage 108 can be provided to a dosing system 216. For example, the device or system on which the corrosion inhibitor optimizer 100 is implemented (e.g., the computing device 102, as shown in FIG. 1) can communicate with the dosing system 216 over a network 218, for example, as described herein. For example, the corrosion inhibitor optimizer 100 can cause a signal (e.g., an electrical (e.g., an analog or a digital signal), an optical, a radio-frequency (RF) signal, etc.) representative of the inhibitor dosage 108 to be sent to the dosing system 216. The dosing system 216 can adjust a corrosion inhibitor set point (or dosing set point) to adjust an injection rate of the corrosion inhibitor by an injection pump 220 into the pipeline based on the inhibitor dosage 108.

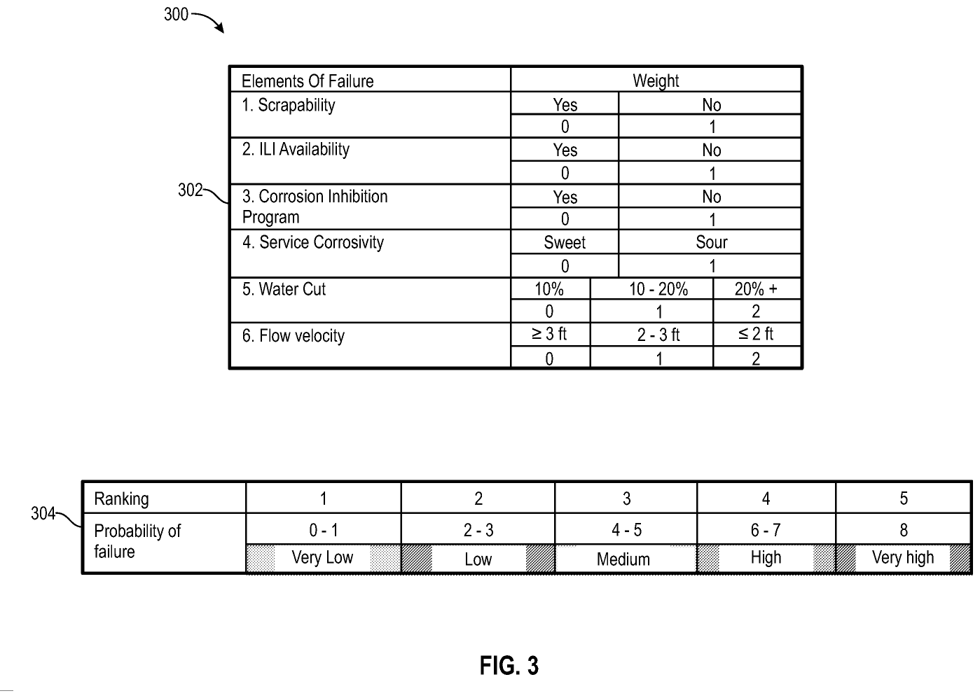

FIG. 3 is an example of source tables 300 that can be used for computing a failure probability ranking according to the examples described herein. The tables 300 include a probability factors table 302 and a probability ranking table 304, which can correspond to the failure probability factors table and probability ranking table, as described herein with respect to FIG. 1. Thus, reference can be made to the example of FIGS. 1-2 in the example of FIG. 3.

As described herein, the failure probability and consequence calculator 110 can generate the failure probability data 118 that includes the ranking based on the probability factors table 302 and the probability ranking table 304, which can be used by the concentration engine 122 for computing the target inhibitor concentration 132, as shown in FIG. 1. For example, the probability factors table 302 includes a number of values (weights) for each element, and as described herein. The failure probability and consequence calculator 110 can compute an overall ranking corresponding the failure probability using the values from the probability factors table 302.

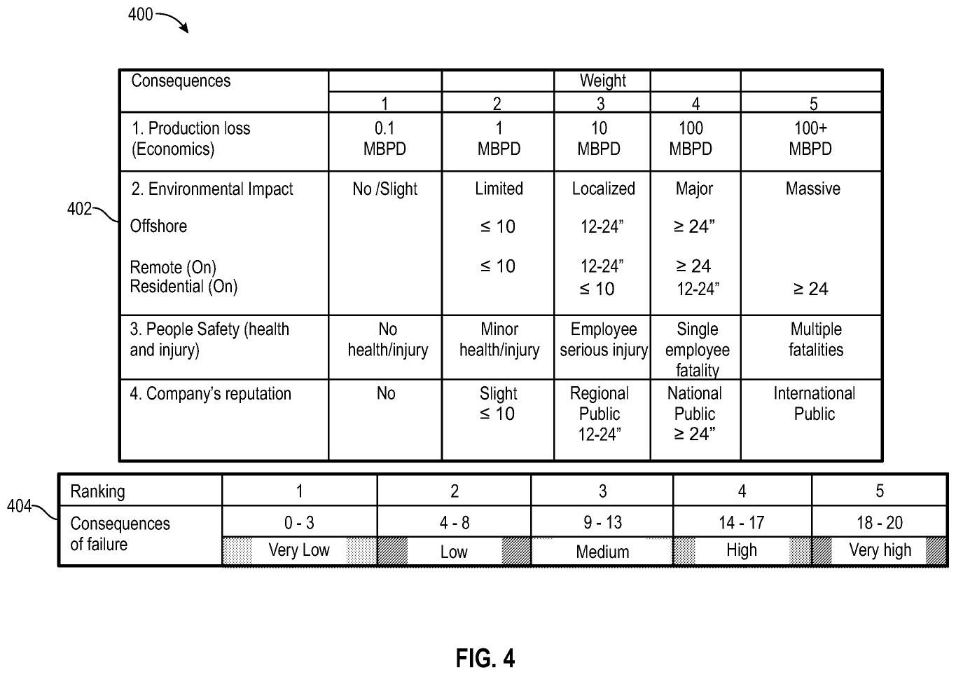

FIG. 4 is an example of consequence tables 400 that can be used for computing a failure consequence ranking according to the examples described herein. The tables 400 include a failure consequence factors table 402 and a failure consequence ranking table 404, which can correspond to the failure consequence factors table and consequence ranking table, as described herein with respect to FIG. 1. Thus, reference can made to the example of FIGS. 1-2 in the example of FIG. 4.

As described herein, the failure probability and consequence calculator 110 can generate the consequence data 120 that includes the consequence ranking based on the consequence factors table 402 and the consequence ranking table 404, which can be used by the concentration engine 122 for computing the target inhibitor concentration 132, as shown in FIG. 1. For example, the consequence factors table 402 includes a number of values for each consequence element/factor. The failure probability and consequence calculator 110 can compute an overall ranking corresponding the consequence level according to the values of the consequence factors table 402.

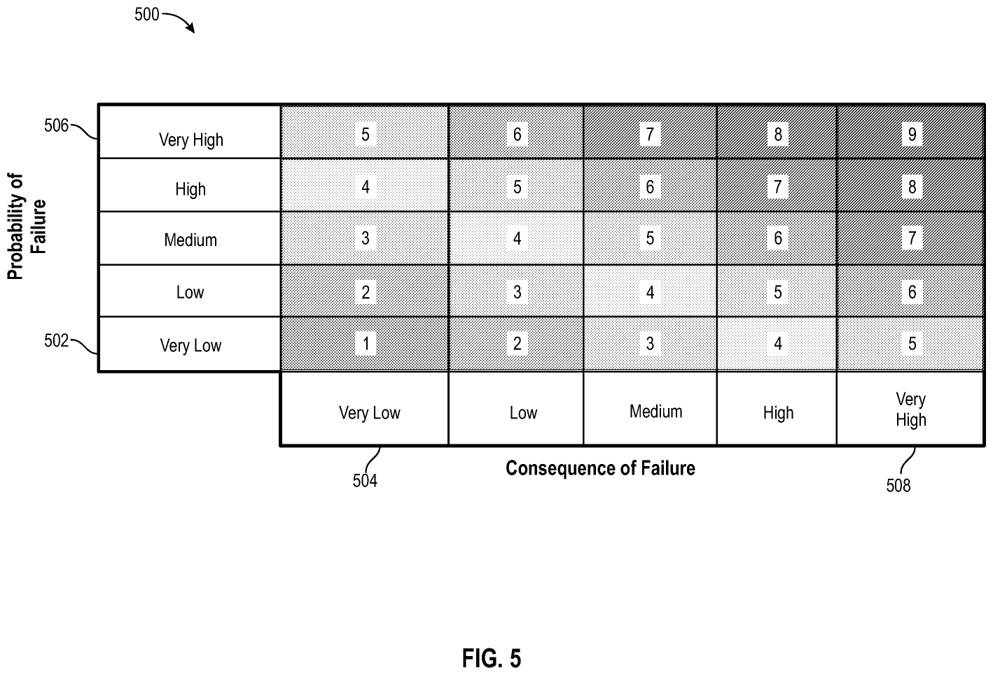

FIG. 5 is an example of a matrix 500 with cells assigned an associated risk level. FIG. 6 is an example of a matrix 600 with cells assigned an associated inhibitor concentration. In some examples, such as the second example described herein, the matrix 600 can correspond the risk matrix 126, as shown in FIG. 1. In other examples, the matrix 600 can correspond to the risk matrix 126 in which an associated risk level for each cell, such as from FIG. 5, has been omitted for clarity and brevity purposes. Thus, reference can be made to the example of FIGS. 1-4 in the example of FIGS. 5-6.

Each row in each of the matrices 500-600 can specify a given likelihood of pipeline corrosion failure (identified as “Probability of Failure” in the example of FIGS. 5-6), and each column in each of the matrices 500-600 can specify a given consequence level from the pipeline corrosion failure (identified as “Consequence of Failure” in the example of FIGS. 5-6). As shown, in each of the FIGS. 5-6, a first row 502 and 602 of the matrices 500 and 600, respectively, can be assigned a low likelihood of pipeline corrosion failure, and a first column 504 and 604 of the matrices 500 and 600, respectively, is assigned a lowest level of a consequence from the pipeline corrosion failure. By way of further example, as shown, in each of the FIGS. 5-6, a last row 506 and 606 of the matrices 500 and 600, respectively, is assigned a highest likelihood of pipeline corrosion failure, and a last column 508 and 608 of the matrices 500 and 600, respectively, is assigned a highest level of a consequence from the pipeline corrosion failure.

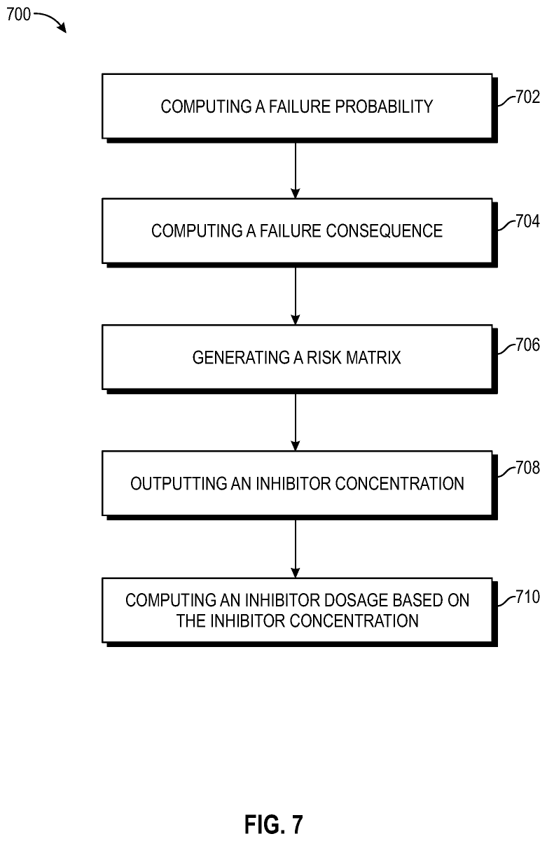

In view of the foregoing structural and functional features described above, example methods will be better appreciated with reference to FIGS. 7-9. While, for purposes of simplicity of explanation, the example methods of FIGS. 7-9 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

FIG. 7 is an example of a method 700 for determining an inhibitor dosage of a corrosion inhibitor for mitigating or reducing pipeline corrosion (e.g., the pipeline 210, as shown in FIG. 2). The method 700 can be implemented by the corrosion inhibitor optimizer 100, as shown in FIG. 1. Thus, reference can be made to the example of FIGS. 1-6 in the example of FIG. 7.

The method 700 can begin at 702 by computing (e.g., by the probability and consequence calculator 110, as shown in FIG. 1) a failure probability representative of a likelihood of a pipeline corrosion failure based on probability factors table (e.g., the probability factors table 302, as shown in FIG. 3) and a probability ranking table (e.g., the probability ranking table 304, as shown in FIG. 4). At 704, computing (e.g., by the probability and consequence calculator 110) a consequence level representative of consequence from the pipeline corrosion failure based on a consequence factors table (e.g., the consequence factors table 402, as shown in FIG. 4) and a consequence ranking table (e.g., the consequence ranking table 404, as shown in FIG. 4).

At 706, generating (e.g., by the concentration engine 122, as shown in FIG. 1) a risk matrix (e.g., the risk matrix 126, as shown in FIG. 1) that includes a number of cells with assigned risk levels (and in some instances assigned inhibitor concentrations). At 708, outputting (e.g., by the concentration engine 122) an inhibitor concentration (e.g., the target inhibitor concentration 132, as shown in FIG. 1) for a given risk level from the assigned risk levels in response to applying the failure probability and consequence to the risk matrix. At 710, computing (e.g., by the inhibitor dosage controller 134, as shown in FIG. 1) the inhibitor dosage (e.g., the inhibitor dosage 108, as shown in FIG. 1) based on at least the inhibitor concentration.

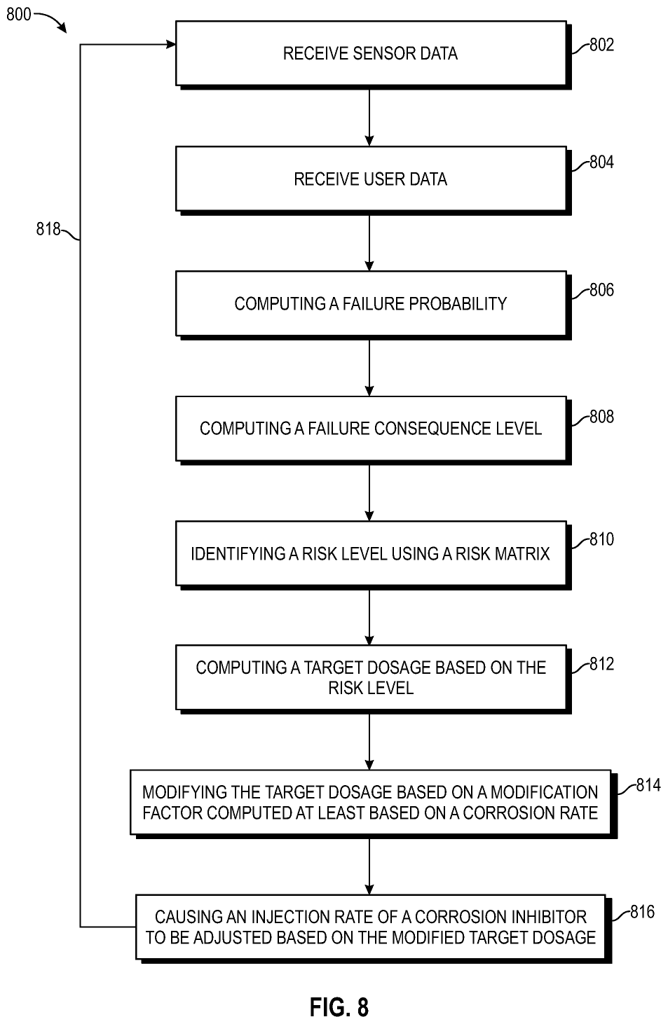

FIG. 8 is an example of a method 800 for optimizing an injection rate of a corrosion inhibitor into a pipeline (e.g., the pipeline 210, as shown in FIG. 2). The method 800 can be implemented by the corrosion inhibitor optimizer 100, as shown in FIG. 1. Thus, reference can be made to the example of FIGS. 1-6 in the example of FIG. 8. The method 800 can begin at 802 by receiving or retrieving (e.g., by the probability and consequence calculator 110, as shown in FIG. 1) sensor data (e.g., the sensor data 112, as shown in FIG. 1). The sensor data can include a number of measurements from sensors distributed or located on the pipeline for measuring physical changes in an environment (e.g., within the pipeline) that contribute to or cause pipeline corrosion. At 804, receiving or retrieving (e.g., by the probability and consequence calculator 110) user data (e.g., the user data 114, as shown in FIG. 1) is performed. The user data can include information/data identifying corrosion mitigation methodologies that are used by an operator for pipeline corrosion reduction and the pipeline operational conditions, and consequences from corrosive effects on the pipeline.

At 806, computing (e.g., by the probability and consequence calculator 110) a failure probability representative of a likelihood of a pipeline corrosion failure based on a probability factors table (e.g., the probability factors table 302, as shown in FIG. 3) and a probability ranking table (e.g., the probability ranking table 304, as shown in FIG. 3) is performed. The probability factors table can be computed based on the sensor and user data. At 808, computing (e.g., by the probability and consequence calculator 110) a consequence level representative of a consequence from the pipeline corrosion failure based on a consequence factors table (e.g., the consequence factors table 402, as shown in FIG. 4) and a consequence ranking table (e.g., the consequence ranking table 404, as shown in FIG. 4) is performed. The consequence factors table can be computed based on the user data.

At 810, identifying (e.g., by the concentration engine 122, as shown in FIG. 1) a risk level using a risk matrix (e.g., the risk matrix 126, as shown in FIG. 1) to identify an associated inhibitor concentration (e.g., the target inhibitor concentration 132, as shown in FIG. 1) based on the failure probability and the consequence is performed. At 812, computing (e.g., by the inhibitor dosage controller 134, as shown in FIG. 1) an inhibitor dosage (e.g., the inhibitor dosage 108, as shown in FIG. 1) for the corrosion inhibitor based on at least the target inhibitor concentration is performed. At 814, modifying the inhibitor dosage based on a modification factor (e.g., the MF 136, as shown in FIG. 1) computed at least based on a corrosion rate (e.g., the measured corrosion rate 142, as shown in FIG. 1) measured for the pipeline is performed. At 816, causing the corrosion inhibitor to be injected at the injection rate into the pipeline based on the modified inhibitor dosage is performed. In some examples, at 818, the steps 802-816 can be repeated to adjust the injection rate of the corrosion inhibitor into the pipeline. Repeating the steps 802-816 over time or over a number of iterations can optimize the injection rate of the corrosion inhibitor as pipeline conditions change.

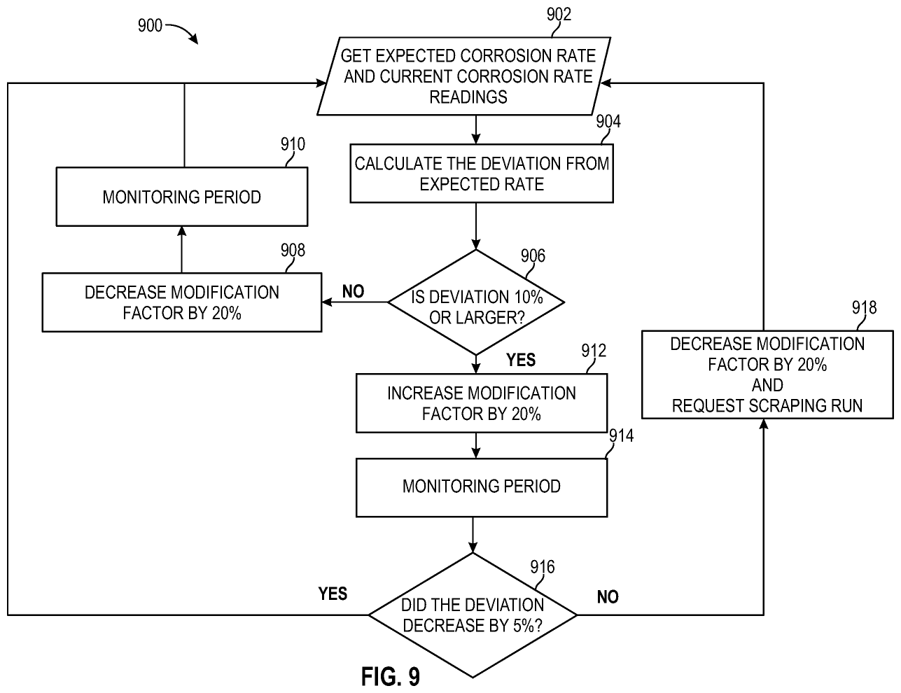

FIG. 9 is an example of a method 900 for setting a modification factor (e.g., the MF 136, as shown in FIG. 1) for inhibitor dosage adjustment. The method 900 can be implemented by the corrosion inhibitor optimizer 100, as shown in FIG. 1. Thus, reference can be made to the example of FIGS. 1-8 in the example of FIG. 9. The method 900 can be implemented by the corrosion inhibitor optimizer 100 in response to or after computing an inhibitor dosage and thus in response to or after the step 710, as shown in FIG. 7, or the step 812, as shown in FIG. 8. Thus, in some examples, the method 900 can be implemented as part of the method 700, as shown in FIG. 7, or the method 800, as shown in FIG. 8.

For example, the method 900 can begin at 902 by receiving or retrieving (e.g., by the modification calculator 138, as shown in FIG. 1) an expected corrosion rate (e.g., from the reference corrosion data 140, as shown in FIG. 1) and a current corrosion rate (e.g., the measured corrosion rate 142, as shown in FIG. 1) for the pipeline. At 904, computing (e.g., by the modification factor calculator 138) a corrosion deviation amount (e.g., as a percentage) from the expected corrosion rate is performed. At 906, determining whether the corrosion deviation amount (expressed as a given percentage) is greater than a corrosion deviation amount threshold is performed. In the example of FIG. 9, at step 906, the given percentage is 10%, however, in other examples, a different percentage value can be used.

At 908, (e.g., by the modification factor calculator 138) the modification factor (e.g., the MF 136, as shown in FIG. 1) is decreased by a percentage factor to provide a decreased modification factor in response to determining that the corrosion deviation amount is less than the corrosion deviation amount threshold, which is shown with a “No” in the example of FIG. 9. In some examples, the method 900 can proceed from step 908 to step 814, as shown in FIG. 8, to modify an inhibitor dosage rate based on the decreased modification factor. In the example of FIG. 9 the percentage factor is shown as 20%; however, in other examples, a different percentage can be used. At 910, a monitoring period or phase (e.g., by the modification calculator 138) is entered for a period of time during which the modification factor is not adjusted (e.g., by the modification factor calculator 134, as shown in FIG. 1) is performed. At an expiration of the monitoring period or phase, the method 900 can return to step 902 from step 910, as shown in FIG. 9.

In some examples, the method 900 proceeds to step 912 in response to determining that the corrosion deviation amount is greater than the corrosion deviation amount threshold, which is shown with a “Yes” in the example of FIG. 9. At 912, the modification factor (e.g., the MF 136) is increased by the percentage factor (e.g., by the modification calculator 138) to provide an increased modification factor in response to determining that the corrosion deviation amount is more than the corrosion deviation amount threshold to adjust an inhibitor dosage. In some examples, the method 900 can proceed from step 912 to step 814, as shown in FIG. 8, to modify an inhibitor dosage rate based on the increased modification factor. At 914, the monitoring period or phase (e.g., by the modification factor calculator 138) is entered for the period of time during which the modification factor is not adjusted (e.g., by the modification factor calculator 134, as shown in FIG. 1). At the expiration of the monitoring period or phase, at 916, determining (e.g., by the modification calculator 138) whether the corrosion deviation amount decreased by a threshold is performed.

In some examples, the method 900 can proceed from step 916 back to step 902 in response to determining that the corrosion deviation amount decrease by a threshold, which is shown as a “Yes” in the example of FIG. 9. In some examples, at 918, the modification factor (e.g., the MF 136) is decreased by the percentage factor (e.g., by the modification calculator 138) in response to determining that the corrosion deviation amount did not decrease by a threshold. Further, at 918, or in response to step 918, a corrective action request (e.g., the corrective action request 146, as shown in FIG. 1) is outputted (e.g., by the modification calculator 138) to alert or notify an operator that manual cleaning of the pipeline is needed. In the example of FIG. 9, the manual cleaning is scraping of the pipeline to remove contaminants and/or substances that may be impeding inhibitor flow through the pipeline. The method 900 can proceed to step 902 in response to decreasing the modification factor and outputting of the correction action request.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

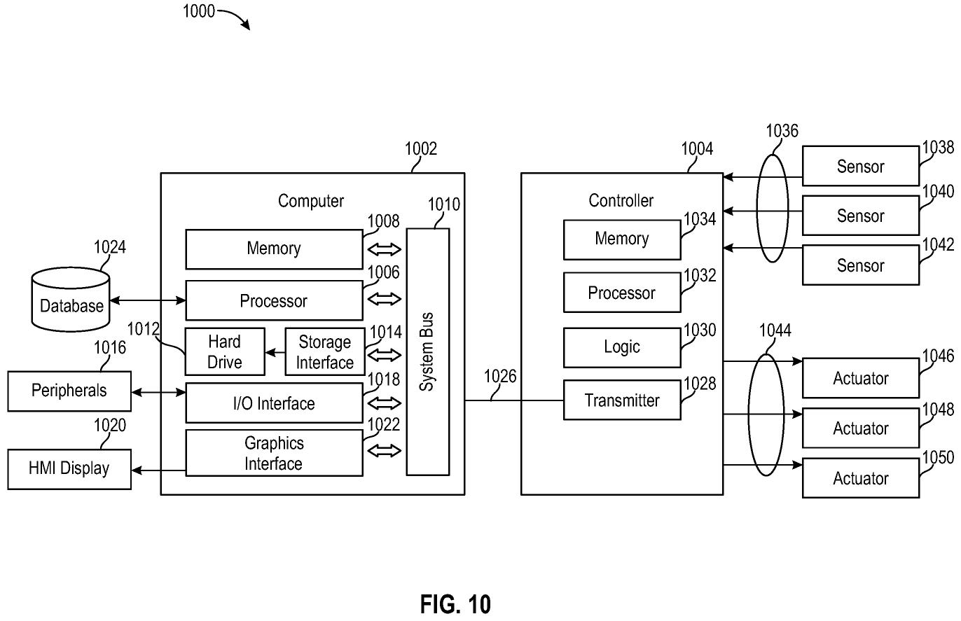

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to a corrosion mitigation system, as shown in FIG. 10. Furthermore, portions of the embodiments may be a computer program product on a computer-usable storage medium having computer readable program code on the medium.

Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer system, such as a computer system 1002, as shown in FIG. 10, or other programmable data processing apparatus, such as a PLC controller 1004, as shown in FIG. 10, to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 10 illustrates one example of a corrosion mitigation system 1000 that can be employed to execute one or more embodiments of the present disclosure. The corrosion mitigation system 1000 can include the computer system 1002 and the PLC controller 1004. The computer system 1002 can be implemented as one or more general purpose networked computer systems, embedded computer systems, routers, switches, server devices, client devices, various intermediate devices/nodes or standalone computer systems. Additionally, the computer system 1002 can be implemented on various mobile clients such as, for example, a personal digital assistant (PDA), laptop computer, pager, and the like, provided it includes sufficient processing capabilities.

The computer system 1002 includes a processing unit 1006, a system memory 1008, and a system bus 1010 that couples various system components, including the system memory 1008, to processing unit 1006. Dual microprocessors and other multi-processor architectures also can be used as processing unit 1006. System bus 1010 may be any of several types of bus structure including a memory bus or memory controller, a peripheral bus, and a local bus using any of a variety of bus architectures. System memory 1008 includes read only memory (ROM) and random access memory (RAM). A basic input/output system (BIOS) can reside in ROM containing the basic routines that help to transfer information among elements within computer system 1002.

The computer system 1002 can include a hard disk drive 1012. The hard disk drive 1012 can be connected to system bus 1010 by a hard disk drive (or storage) interface 1014. Peripherals 1016 (e.g., keyboard, mouse, optical disk drive, magnetic disk drive, etc.) can be connected to the system bus 1010 by an input-output (I/O) interface 1018. One or more human machine interface (HMI) displays 1020 can be coupled by a graphics interface 1022 to the system bus 1010, as shown in FIG. 10. In some examples, the one or more HMI displays 1020 are one or more output devices. The one or more output devices (e.g., display, a monitor, printer, projector, or other type of displaying device) can be connected to system bus 1020 via the interface 1022, such as a video adapter. The drive(s) and associated computer-readable media provide nonvolatile storage of data, data structures, and computer-executable instructions for the computer system 1002. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM, including operating system, one or more application programs, other program modules, and program data. In some examples, the computer system 1002 can be used to implement the corrosion inhibitor optimizer 100, as shown in FIG. 1, and other examples, the PLC controller 1004 can be used to implement the corrosion inhibitor optimizer 100. In some examples, some of the functionality as described herein is implemented by the computer system 1002 and other functionality as described herein is implemented by the PLC controller 1004. The processing unit 1006 can communicate with a database 1024 that can store relevant information (e.g., the user data 114, as shown in FIG. 1).

A user may enter commands and information into computer system 1002 through one or more peripherals 1016, for example one or more input devices, such as a pointing device (e.g., a mouse, touch screen), keyboard, microphone, joystick, game pad, scanner, and the like. These and other input devices are often connected to processing unit 1006 through a corresponding I/O interface 1018 (e.g., port interface) that is coupled to the system bus 1010, but may be connected by other interfaces, such as a parallel port, serial port, or universal serial bus (USB).

The computer system 1002 may operate in a networked environment using one or more connections to one or more remote computers, such as remote computer (not shown in FIG. 10), and to the PLC controller 1004. In the example of FIG. 10, the one or more connections between the computer system 1002 and the PLC controller is indicated at 1026. The remote computer may be a workstation, computer system, router, peer device, or other common network node, and typically includes many or all the elements described relative to computer system 1002. The one or more logical connection can include a local area network (LAN) and a wide area network (WAN). When used in a LAN networking environment, computer system 1002 can be connected to the local network through a network interface or adapter. When used in a WAN networking environment, computer system 1002 can include a modem, or can be connected to a communications server on the LAN. The modem, which may be internal or external, can be connected to system bus 1010 via an appropriate port interface. In a networked environment, the application programs or program data of computer system 1002, or portions thereof, may be stored in a remote memory storage device.

The PLC controller 1004 can include a transmitter 1028 that enables the PLC controller 1004 to communicate with the computer system 1002 using the one or more connections 1026, as shown in FIG. 10. In some examples, the computer system 1002 can include a transmitter, which can be used to communicate with the PLC controller 1004. For example, the PLC controller 1004 can communicate with the computer system 1002 to receive data and/or commands. The data can include, for example, the user data 114, as shown in FIG. 1. In some examples, the PLC controller 1004 can provide sensor data or feedback data to the computer system 1002, which can be rendered on the HMI display 1020.

The PLC controller 1004 includes logic 1030, a processing unit 1032, and a memory 1034. For clarity and brevity purposes, other elements of the PLC controller 1004 have been omitted, such as input/out interfaces, a power supply, etc. The memory 1034 can be implemented in a same or similar manner as the system memory 1008. The PLC controller 1004 can be part of a distributed control system (DCS), such as of a plant.

In some examples, the logic 1030 includes the corrosion inhibitor optimizer 100, as shown in FIG. 1. The processing unit 1032 can execute the logic 1030 to implement at least some of the functionality as describe herein. In some examples, the memory 1034 includes the logic 1030, and the processing unit 1032 can access the memory 1034 and execute the logic 1030. For example, the PLC controller 1004 can be connected using connections 1036 to a number of respective sensors 1038-1042. The respective sensors can provide corresponding sensor data, which can be stored as or part of the sensor data 112, as shown in FIG. 1. Thus, in some examples, the sensors 1038-1042 can include a water cut sensor, H₂S sensor, CO₂ sensor, a flow meter, etc.

As described herein, the corrosion inhibitor optimizer 100 can determine an inhibitor dosage (e.g., the inhibitor dosage 108, as shown in FIG. 1). The PLC controller 1004 can be connected using connections 1044 to a number of respective actuators 1046-1050. The inhibitor dosage can be used to modify a corrosion inhibitor injection requirement (e.g., set point) and adjust an injection pump rate (e.g., of the injection pump 220, as shown in FIG. 2) by sending appropriate control signals to a dosing system (e.g., as described herein) for the actuators 1046-1050. Thus, in some examples, the corrosion inhibitor optimizer 100 can cause the PLC controller 1004 to generate the control signals based on the inhibitor dosage 108, which can be received by the dosing system (e.g., the dosing system 216, as shown in FIG. 2) to control the actuators to control the dosage rate of the inhibitor into a pipeline.

The invention claimed is:

1. A method comprising:
computing, by one or more processors, a failure probability representative of a likelihood of a pipeline corrosion failure;
computing, by the one or more processors, a consequence level representative of a consequence from the pipeline corrosion failure;
generating, by the one or more processors, a risk matrix;
identifying, by the one or more processors, an inhibitor concentration using the risk matrix based on the failure probability and consequence level; and
computing, by the one or more processors, a dosage of a corrosion inhibitor for mitigating corrosion of a pipeline based on at least the inhibitor concentration.

2. The method of claim 1, wherein the failure probability is computed based on a probability factors table and a probability ranking table, and the consequence level is computed based on a consequence factors table and a consequence ranking table.

3. The method of claim 2, further comprising:
receiving or retrieving, by the one or more processors, sensor data, wherein the sensor data includes a number of measurements from sensors distributed or located on the pipeline for measuring physical changes with respect to the pipeline that contribute to or cause corrosion of the pipeline; and
receiving or retrieving, by the one or more processors, user data, wherein the user data can include information/data identifying corrosion mitigation methodologies that are used by an operator for pipeline corrosion reduction and pipeline operational conditions, and consequences from corrosive effects on the pipeline, and
wherein the probability ranking table is computed based on the sensor and user data, and the consequence ranking table can be computed based on the user data.

4. The method of claim 1, wherein the computing the dosage comprises modifying, by the one or more processors, the dosage to provide a modified dosage based on a modification factor computed at least based on a corrosion rate measured for the pipeline.

5. The method of claim 4, wherein adjusting the inhibitor dosage comprises, multiplying, by the one or more processors, the inhibitor dosage by the modification factor to provide an updated inhibitor dosage.

6. The method of claim 4, further comprising causing, by the one or more processors, the corrosion inhibitor to be injected at an injection rate into the pipeline based on the modified dosage.

7. The method of claim 4, further comprising:
receiving or retrieving, by the one or more processors, an expected corrosion rate and the corrosion rate measured for the pipeline;
computing, by the one or more processors, a corrosion deviation amount from the expected corrosion rate; and
determining, by the one or more processors, whether the corrosion deviation amount is greater than a corrosion deviation amount threshold.

8. The method of claim 7, further comprising one of:
providing, by the one or more processors, the modification factor with a first value or percentage in response to determining that the corrosion deviation amount is less than the corrosion deviation amount threshold; and
providing, by the one or more processors, the modification factor with a second value or percentage that is larger than the first value or percentage in response to determining that the corrosion deviation amount is greater than the corrosion deviation amount threshold.

9. The method of claim 8, wherein in response to providing the modification factor with the second value or percentage, the dosage is not modified based on the modification factor for a period of time, and after the period of time, the method further comprises:
determining, by the one or more processors, whether the corrosion deviation amount decreased by a threshold; and
decreasing the modification factor in response to determining that the corrosion deviation amount did not decrease by the threshold.

10. The method of claim 9, further comprising outputting, by the one or processors, data representative of a corrective action request indicating a request for manual cleaning of the pipeline in response to determining that the decrease in corrosion deviation amount is less than a threshold.

11. The method of claim 10, further comprising causing, by the one or more processors, the data representative of the corrective action request to be provided to a user device or rendered on a display.

12. A system comprising:
memory to store machine-readable instructions and data, the data comprising a probability factors table, a probability ranking table, a consequence factors table and a consequence ranking table;
one or more processors operable to access the memory and execute the machine-readable instructions, the machine-readable instructions comprising a corrosion inhibitor optimizer that includes:
a failure probability and consequence calculator programmed to:
compute a failure probability representative of a likelihood of a pipeline corrosion failure based on the probability factors table and the probability ranking table;
compute a consequence level representative of a consequence from the pipeline corrosion failure based on the consequence factors table and the consequence ranking table;
a concentration engine programmed to identify a risk level using a risk matrix to identify an associated inhibitor concentration based on the failure probability and consequence level; and
an inhibitor dosage controller programmed to compute a dosage for the corrosion inhibitor based on the identified risk level.

13. The system of claim 12, wherein the inhibitor dosage controller is further programmed to modify the dosage to provide a modified dosage based on a modification factor computed at least based on a corrosion rate measured for the pipeline.

14. The system of claim 13, wherein the inhibitor dosage controller is further programmed to cause the corrosion inhibitor to be injected at the injection rate into the pipeline based on the modified dosage.

15. The system of claim 13, wherein the corrosion inhibitor optimizer further comprises a modification calculator programmed to:
receive or retrieve an expected corrosion rate and the corrosion rate measured for the pipeline;
compute a corrosion deviation amount from the expected corrosion rate; and
determine whether the corrosion deviation amount is greater than a corrosion deviation amount threshold.

16. The system of claim 15, wherein the modification calculator is further programmed to one of:
provide the modification factor with a first value or percentage in response to determining that the corrosion deviation amount is less than the corrosion deviation amount threshold; and
provide the modification factor with a second value or percentage that is greater than the first value or percentage in response to determining that the corrosion deviation amount is greater than the corrosion deviation amount threshold.

17. The system of claim 16, wherein in response to providing the modification factor with the second value or percentage, the modification calculator is disabled, such that the dosage is not modified based on the modification factor for a period of time, and after the period of time the modification calculator is enabled, wherein in response to being enabled the modification calculator is further programmed to:
determine whether the corrosion deviation amount decreased by a threshold, and
decrease the modification factor in response to determining that the corrosion deviation amount did not decrease by the threshold.

18. The system of claim 17, wherein the modification calculator or the inhibitor dosage controller is further programmed to provide data representative of a corrective action request indicating a request for manual cleaning of the pipeline in response to determining that the decrease in corrosion deviation is less than a threshold.

19. The system of claim 18, wherein the modification calculator or the inhibitor dosage controller is further programmed to cause the data representative of the corrective action request to be provided to a user device or rendered on a display.
